(19) United States
(12) Patent Application Publication
(10) Pub. No.: US 2009/0015866 A1
(43) Pub. Date: Jan. 15, 2009

(54) Printing apparatus having authenticated printing functionality

(75) Inventor: Manabu Iwamoto, Amimachi (JP)

Correspondence Address: THE NATH LAW GROUP, 112 South West Street, Alexandria, VA, 22314, US

(73) Assignee: RISO KAGAKU CORPORATION, Minato-ku (JP)

(21) Appl. No.: 12/216,827

(22) Filed: Jul. 11, 2008

(30) Foreign Application Priority Data
Jul. 13, 2007 (JP) 2007-184920

(51) Int. Cl. G06F 3/12

(52) U.S. Cl. 358/1.15; 715/771; 726/21

(57) ABSTRACT

A printing apparatus 10 is provided with authenticated printing functionality and make it easy to select print data items to be printed after authentication. The printing apparatus 10 comprises a print information storage unit 180 operable to store, in association with each other, print data and information on whether or not authentication is required when a print data item is printed, and a display unit operable to display a list of print data items which are stored in the print information storage unit in order that the user can select a print data item to be printed with reference to this list. The display unit displays a first list containing the print data items that require authentication in a first screen, and displays a second list containing the print data items that don't require authentication in a second screen different than the first screen.

### BACKGROUND OF THE INVENTION

1. Field of the Invention

The present invention relates to a printing apparatus, and particularly, relates to a printing apparatus having authenticated printing functionality to perform a print process after the user is authenticated.

2. Description of the Background Art

In the case of a network printing system implemented with a printing apparatus connected to a computer network, it is popular that a plurality of computers share the printing apparatus. Because of this, the printing apparatus outputs a variety of printing results in response to requests from different users. However, the printed materials may include materials which are wanted to be kept out of sight, and secret materials relating to highly confidential information. There are known printing apparatuses which are provided with authenticated printing functionality for the purpose of protecting privacy and secrecy of such printed materials (for example, as described in Japanese Patent Published Application No. 2002-240398).

When a user selects an authenticated printing option for a printing material, the printing apparatus provided with authenticated printing functionality defers output of the printing material, and performs the actual outputting only when the user is authenticated by the printing apparatus at the location where the printing apparatus outputs printed sheets. By this functionality, the user can obtain the printing results while remaining the printed material out of sight.

When the user actually performs the authenticated printing process after authentication at the location where the printing apparatus outputs printed sheets, he has to identify the print material to be printed. Generally speaking, the user can identify the print material to be printed by selecting it from the list showing print materials which are accepted by the printing apparatus.

However, in the case where there are a large number of the print materials accepted by the printing apparatus, it takes a lot of trouble to find the print material to be printed by searching the list in which are displayed both the print jobs relating to ordinary printing items and the print jobs relating to authenticated printing items. Because of this, the authenticated printing functionality places a substantial burden on the user.

### SUMMARY OF THE INVENTION

Taking into consideration the above circumstances, it is an object of the present invention to make it easy to select print data items to be printed after authentication when using an printing apparatus provided with authenticated printing functionality.

In order to accomplish the object as described above, a printing apparatus is provided with authenticated printing functionality to perform a print process when a user is successfully authenticated, said printing apparatus, and comprises: a print information storage unit operable to store print data and information on whether or not authentication is required when a print data item is printed on a sheet, the print data item and the information being associated with each other; and a display unit operable to display a list of print data items which are stored in said print information storage unit in order that the user can select a print data item to be printed with reference to this list, wherein said display unit displays a first list containing the print data items that require authentication in a first screen, and displays a second list containing the print data items that don't require authentication in a second screen different than the first screen.

In accordance with the present invention, the selection of print data items is made easy when using the printing apparatus provided with the authenticated printing functionality, since the print data items that require authentication and the print data items that don't require authentication are separately displayed.

In accordance with a preferred embodiment of the present invention, said print information storage unit stores each print data item together with a user identifier which is associated with this each print data, and further comprises: a user information storage unit is further provided for storing the user identifier and authentication information in association with each other, and an authentication unit is further provided for performing authentication of the user on the basis of the authentication information. The display unit displays an authentication screen in which the user can perform authentication by said authentication unit in advance of displaying the list of the print data items that require authentication. After the user performs authentication, said display unit displays the list of the print data items that require authentication and are associated with the user identifier relating to this authentication.

This is because it is preferred that the list of the print data items that require authentication can be viewed only by the user associated with the print data items by the authentication information.

On the other hand, since there seems to be nothing wrong if any user can view the list of the print data items that don't require authentication, the display unit can dispense with displaying the authentication screen when it is requested to display the list of the print data items that don't require authentication.

Also, in accordance with a preferred embodiment of the present invention, said display unit switches between the screen displaying the print data items that don't require authentication and the screen displaying the print data items that require authentication in response to an operation by the user. In this case, when said display unit displays the screen displaying the print data items that require authentication, without requiring authentication again, after switching from the screen displaying the print data items that require authentication to the screen displaying the print data items that don't require authentication.

Since the user is authenticated when displaying the list of the print data items that require authentication, the authentication need not be repeated when this list is displayed again. By this configuration, it is possible to lessen the burden on the user.

Furthermore, in accordance with a preferred embodiment of the present invention, the printing apparatus further comprises a nonvolatile storage device in which the print data items are stored. The present invention is effectively applied to a printing apparatus which enables the user to repeat printing the same print data by storing the print data in a nonvolatile storage device.

In accordance with the present invention, the selection of print data items is thereby made easy when using the printing apparatus provided with the authenticated printing functionality.

### BRIEF DESCRIPTION OF THE DRAWINGS

The objects and features of the present invention will become more apparent from consideration of the following detailed description taken in conjunction with the accompanying drawings in which:

FIG. 1 is a schematic diagram for showing an example of the configuration of the network printing system in accordance with an embodiment of the present invention.

FIG. 2 is a block diagram for showing the functional configurations of a printing apparatus 10 and a PC 20 in accordance with the embodiment of the present embodiment.

FIG. 3 is a view for explaining the process of setting the authenticated printing process in accordance with the embodiment of the present embodiment.

FIG. 4A and FIG. 4B are views showing an administrator information table and a user management table respectively stored in a storage device of the printing apparatus in accordance with the embodiment of the present embodiment.

FIG. 5 is a schematic diagram for showing one example of a print setting screen in accordance with the embodiment of the present embodiment.

FIG. 6 is a schematic diagram for showing one example of a data structure provided in a hold area for storing print data in accordance with the embodiment of the present embodiment.

FIG. 7 is a view for explaining the authenticated printing process of “holding data” in a prior authentication mode in accordance with the embodiment of the present embodiment.

FIG. 8 is a view for explaining the authenticated printing process of “holding data” in a usual authentication mode in accordance with the embodiment of the present embodiment.

FIG. 9 is a view for explaining the authenticated printing process of “direct printing” in the prior authentication mode in accordance with the embodiment of the present embodiment.

FIG. 10 is a view for explaining the authenticated printing process of “direct printing” in the usual authentication mode in accordance with the embodiment of the present embodiment.

### DESCRIPTION OF THE PREFERRED EMBODIMENTS

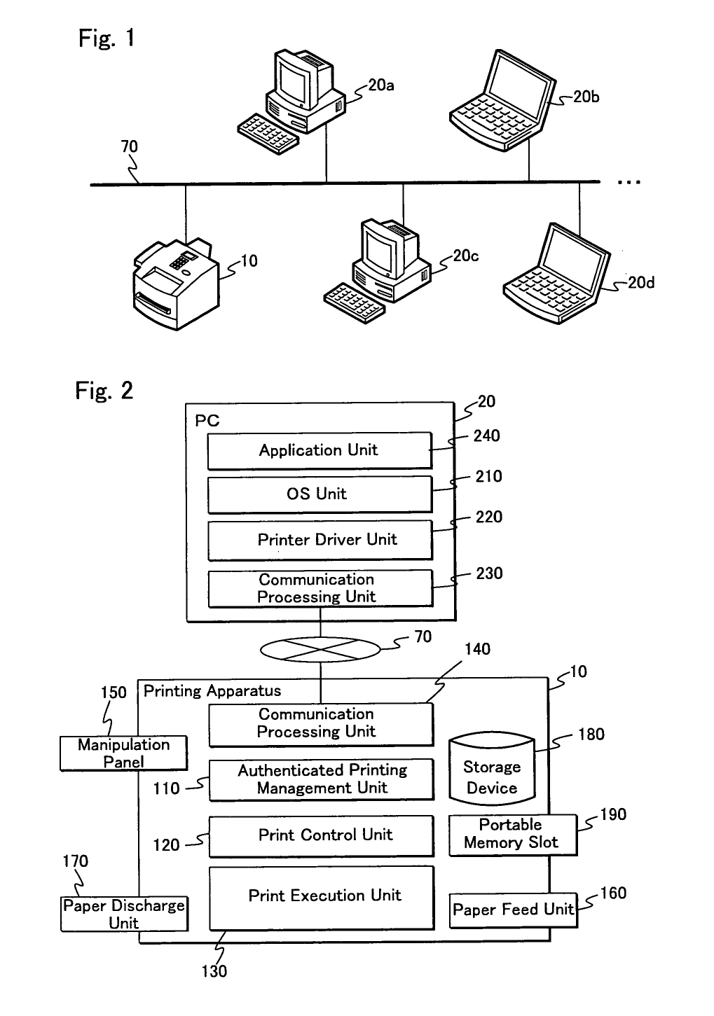

An embodiment in accordance with the present invention will be explained in conjunction with the accompanying drawings. FIG. 1 is a schematic diagram for showing an example of the configuration of the network printing system in accordance with the present invention. As shown in this drawing, there are a printing apparatus 10 and a plurality of personal computers (PC) 20a, 20b . . . connected to the computer network 70 in the network printing system. A printer driver program supporting the printing apparatus 10 is installed in each of the PC 20a, 20b . . . which serves thereby as a print control unit. For example, the network printing system is typically implemented in an office LAN.

FIG. 2 is a block diagram for showing the characteristic functional configurations of the printing apparatus 10 and the PC 20 in accordance with the present embodiment. The network printing system includes a plurality of the PC 20a, 20b . . . only one of which is illustrated in FIG. 2 and referred to simply as the PC 20 in the following description. As shown in this drawing, the printing apparatus 10 includes an authenticated printing management unit 110 which manages the information relating to an authenticated printing option, a print control unit 120 which controls a print process on the basis of print data as transmitted from the PC 20, a print execution unit 130 which is provided with a print engine for performing the print process, a communication processing unit 140 which controls communication with the PC 20 through the computer network 70, an operation panel 150, a paper feed unit 160, a paper discharge unit 170, a nonvolatile storage device 180 and a portable memory slot 190 into which a portable memory can be inserted.

The operation panel 150 is implemented with a touch panel-type display device and serves to accept menu operation from the user, display the information about print processing, and so forth. The storage device 180 can be a hard disk, a memory card or the like. The portable memory slot 190 can accommodate a portable memory, such as a USB memory.

The PC 20 is implemented with an OS (operating system) 210 for providing an I/O function, a file processing system, an basic user interface and the like, a printer driver unit 220 for controlling the printing apparatus 10, a communication processing unit 230 for controlling communication with another PC 20 or the printing apparatus 10 through the computer network 70, and an application unit 240 for providing necessary processing relating to specific jobs such as document preparation, image processing and so forth.

The printer driver unit 220 serves to display a print setting screen, accept the settings of printing options from the user, notify the user of the information about printing process and so forth. The printer driver unit 220 and the application unit 240 are implemented as software runnable on the OS 210.

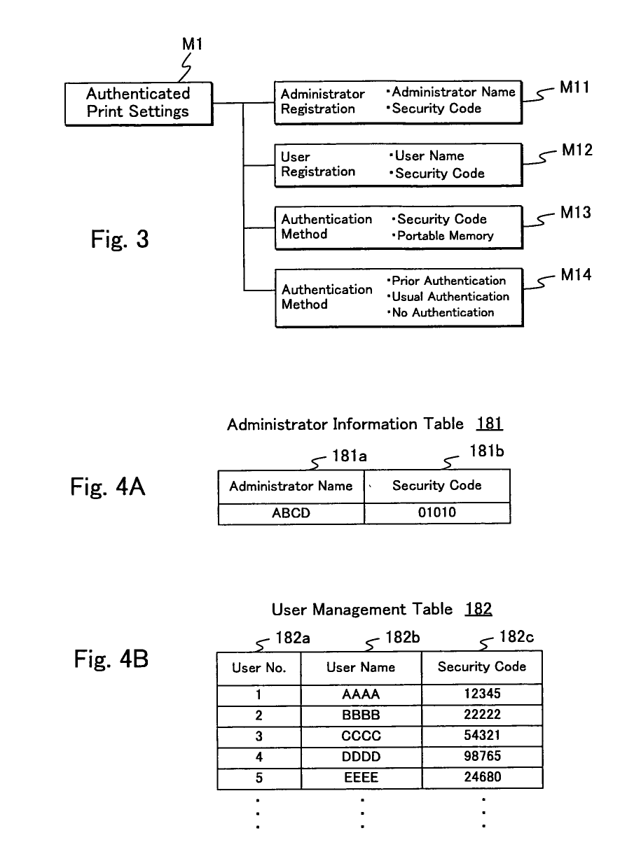

Next, the authenticated printing process in accordance with the present embodiment will be explained. The authenticated printing process is controlled mainly by the authenticated printing management unit 110. The process of setting the authenticated printing process is performed in advance of performing the authenticated printing process. This setting process will be explained with reference to FIG. 3 as follows. The authenticated print setting process is performed, for example, by a network administrator.

As illustrated in FIG. 3, the authenticated print settings M11 include administrator registration M11, user registration M12, the setting of an authentication method M13, and the setting of an authentication mode M14. These settings can be made through the operation panel 150 of the printing apparatus 10. Alternatively, these settings can be made through the printer driver unit 220 of the PC 20.

In the administrator registration M11, an administrator inputs the name of the administrator and a security code in accordance with a menu displayed on the operation panel 150. The information which is input is registered in an administrator information table 181 of the storage device 180 as illustrated in FIG. 4A. The administrator information table 181 includes an administrator name field 181a and a security code field 181b.

In the user registration M12, the administrator inputs user information for each user who uses the network printing system in accordance with a menu displayed on the operation panel 150. User numbers are provided in advance in the printing apparatus 10, and the administrator inputs a user name and a security code in correspondence with each user number. The input information is stored in a user management table 182 of the storage device 180 which contains a user number field 182a, a user name field 182b, and a security code field 182c as illustrated in FIG. 4B. The user information which is registered in the user management table 182 is not limited thereto, but can include other data. For example, a group identifier for identifying the group to which the user belongs, the maximum number of sheets which are printed may be registered as the user information. The user number and security code assigned to each user by the administrator are notified to this each user.

Incidentally, the security code 181b of the administrator information table 181 and the security code 182c of the user management table 182 are the information for identifying each of the administrator and respective users, and thereby it is avoided to redundantly assign the same security code to different ones of the administrator and respective users. Needless to say, the security code is hidden from users other than the user to which this security code is assigned. The user notified of a security code registers the security code in the printer driver unit 220 of the PC 20 which this user uses. When the authenticated printing option is selected, the printing apparatus 10 is notified of the information about which user has requested the authenticated printing by transmitting the security code of the user together with print data to the printing apparatus 10 from the PC 20. However, in place of the transmission of the security code, any appropriate method can be used to notify the printing apparatus 10 of the information about which user has requested the authenticated printing process. For example, the identifier or IP address of the PC 20 can be used to identify the user.

When the user is authenticated, the authentication method M13 is set to either of the methods based on security codes or based on a portable memory such as an USB memory. In the case where “security code” is used for authentication, the user is identified by inputting a security code which is assigned to the user through the operation panel 150. On the other hand, in the case where “portable memory” is used for authentication, while the security code is stored in the portable memory in advance, the user is identified by inserting the portable memory into the portable memory slot 190. In what follows, it is assumed that “security code” is selected. The following description can be applied also to the case where “portable memory” is selected by replacing “inputting a security code” with “inserting a portable memory” in the description.

The authentication mode M14 is set to determine when the user is authenticated. More specifically speaking, one of “prior authentication”, “usual authentication” and “no authentication” is selected as the authentication mode M14. The “prior authentication” mode is a mode in which, irrespective of whether or not the authenticated printing option is selected, the user's authentication is required in advance of starting the operation of the printing apparatus 10. The “usual authentication” mode is a mode in which the user's authentication is required only when the authenticated printing option is selected. The “no authentication” mode is a mode in which the authentication of the user is not performed. In the following description, the explanation of the “no authentication” mode is thereby dispensed with. However, even in this mode, the administrator authentication is performed.

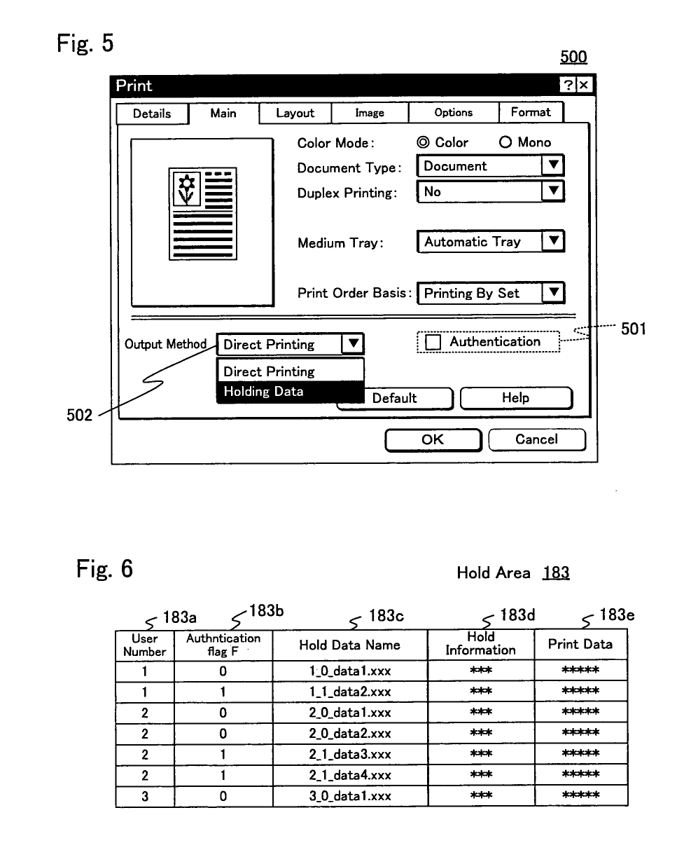

The user can perform the authenticated printing process by selecting the authenticated printing option in a print setting screen which is provided by the printer driver unit 220 of the PC 20. FIG. 5 is a schematic diagram for showing one example of the print setting screen 500. As shown in this figure, the print setting screen 500 includes pull-down menus for designating a color mode, a document type and the like options, and a check box for selecting the authenticated printing option an area 501. The user can select the authenticated printing process by checking this check box.

Also, when print data is transmitted from the PC 20 to the printing apparatus 10, the user can designate how to handle the print data in the printing apparatus 10, i.e., either “direct printing” or “holding data”. The designation can be made through a pull-down menu 502 of the print setting screen 500.

In this case, the “direct printing” is selected to perform a one-time print process, and the print data as transmitted is temporarily saved in the printing apparatus 10 and deleted after the print process is completed. A print job for printing a data item which does not require authentication is executed in the “direct printing” to start the print process without delay in the printing order. A print job for printing a data item which require authentication is executed in the “direct printing” to start the print process after the authentication of the user at the location where the printing apparatus 10 outputs printed sheets.

On the other hand, the “holding data” is selected when it is desired to store the print data in the storage device 180 of the printing apparatus 10. Because of this, it is possible to perform the print job with the printing apparatus 10, as often as needed, at the location where the printing apparatus outputs printed sheets. A print data item which does not require authentication and is transmitted to the printing apparatus 10 in the “holding data”, can be printed without requiring authentication by the printing apparatus 10 at the location where printed sheets are output. On the other hand, a print data item which requires authentication and is transmitted to the printing apparatus 10 in the “holding data”, can be printed after authentication by the printing apparatus 10 at the location where printed sheets are output.

The print data transmitted to the printing apparatus 10 in the “holding data” is stored in a hold area 183 provided in the storage device 180. The print data is managed in a data structure provided in the hold area 183 as illustrated in FIG. 6. Namely, the data structure comprises five members, i.e., user number 183a indicative of a user who has sent print data, authentication F (flag) 183b indicative of whether or not authentication is required, hold data name 183c, hold information 183d such as the date and time of storing data, and print data 183e. When a print job is transmitted to the storage device 180, an instance (or entry) of the data structure is created.

Incidentally, the authentication flag 183b takes “1” when the authenticated printing option is selected, and takes “0” when the authenticated printing option is not selected. A file name can be used as the hold data name 183c. The user number 183a can be identified with reference to the user management table 182 on the basis of the security code as transmitted from the PC 20 together with the print data.

### 1-1) Prior Authentication Mode and Authenticated Printing Process of “Holding Data”

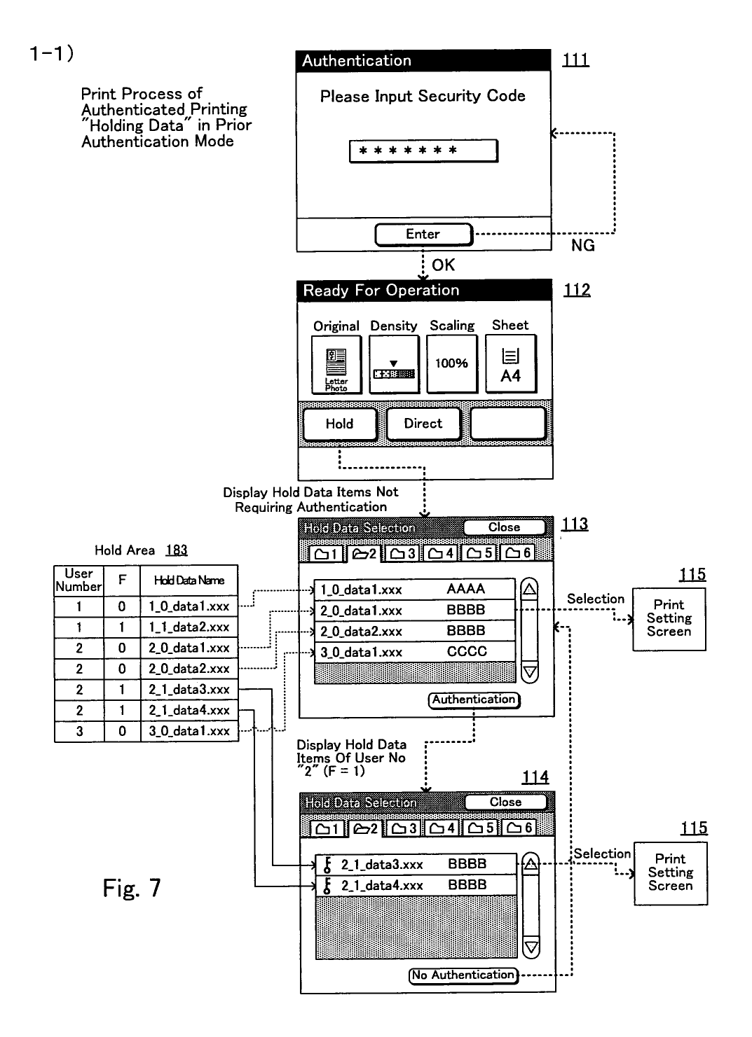

The flow of the process of performing the authenticated printing process will be explained. The following is a description of the authenticated printing process of “holding data” in the prior authentication mode with reference to FIG. 7. Tt is assumed that the data as illustrated in FIG. 6 is stored in the hold area 183 in the storage device 180 of the printing apparatus 10 (part of the data is also illustrated in FIG. 7).

In the prior authentication mode, the authentication of the user is necessarily performed in advance of actually performing the operation of the printing apparatus 10. Because of this, in the prior authentication mode, an authentication ready screen 111 is displayed in a stand-by state for entering a security code on the operation panel 150 of the printing apparatus 10. In this case, it is assumed that “22222” is entered to the authentication ready screen 111 as the security code which is assigned to user “BBBB” corresponding to a user number “2”. By this process, the printing apparatus 10 is notified that the user “BBBB” corresponding to the user number “2” has operated. Incidentally, when a security code which is not registered is entered, the authentication ready screen 111 is displayed again to prompt the user to enter another security code.

After performing the authentication of the user, the printing apparatus 10 displays the operation screen 112 on the operation panel 150 and accepts the operation selected by the user of the user number “2”. The user of the user number “2” can display a list of hold data items by selecting “Hold” in this screen.

When receiving the selection of “Hold”, the printing apparatus 10 displays the list of hold data items which don't require authentication (screen 113). Namely, the data items having the authentication flag of “0” are extracted from among all the data items stored in the hold area 183 and displayed in the screen 113. In this example as illustrated, the hold data relating to all the users and having the authentication flag of “0” are displayed. However, only the hold data relating to the user “BBBB” corresponding to the user number “2 and having the authentication flag of “0” may be displayed. When one of the hold data items displayed in this screen 113 is selected, the print setting screen 115 for the selected hold data item is displayed, and the print process can be actually performed.

When an “authentication” button displayed in this screen 113 is selected, the printing apparatus 10 displays the list of hold data items which require authentication of the user (screen 114). In other words, from among the data items stored in the hold area 183, the data items having the authentication flag of “1” and belonging to the user number “2” are extracted and displayed. The authenticated printing option is indicated in the list by a key mark which is displayed in association with each data item if applicable. In the case of the present embodiment, as described above, the selection of printing items is made easy by separately displaying the list of the data items which require authentication and the list of the data items which don't require authentication.

When one of the hold data items displayed in this screen 114 and requiring authentication is selected, the print setting screen 115 for the selected hold data item is displayed, and the print process can be actually performed. It is possible to select another hold data item after printing the hold data item. In this case, since the authentication of the user has already been performed, this another hold data item can be printed without repeating authentication. Also, when a “no-authentication” button is selected, the list of the data items which don't require authentication is displayed again (screen 113) and the printing apparatus 10 is ready for user's operation.

Incidentally, if a predetermined time elapsed after completing authentication through the authentication ready screen 111, the printing apparatus 10 exits the authenticated state and displays the authentication ready screen 111 again. Alternatively, it is possible to disable the authenticated state by user's operation or the like. Meanwhile, if the user has been authenticated as an administrator in the authentication ready screen 111, it is possible to display in the screen 114 the list of the hold data items of all the users which require authentication.

### 1-2) Usual Authentication Mode and Authenticated Printing Process of “Holding Data”

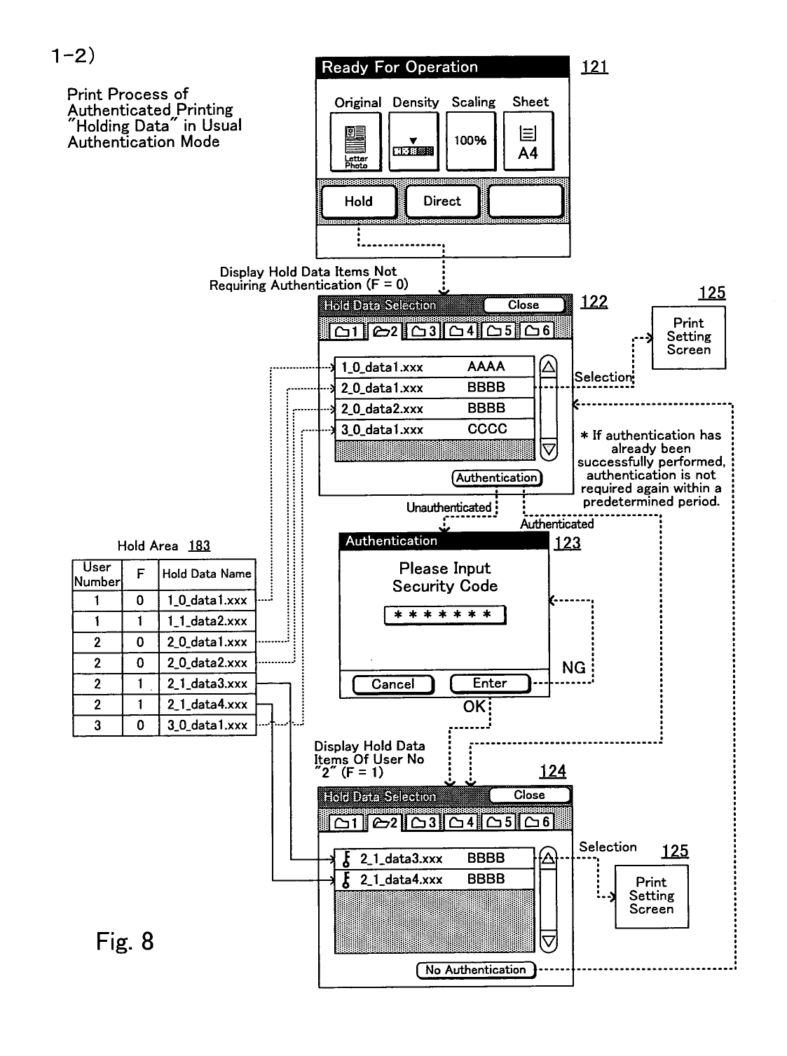

Next is a description of the authenticated printing process of “holding data” in the usual authentication mode with reference to FIG. 8. It is also assumed that the data as illustrated in FIG. 6 is stored in the hold area 183 of the printing apparatus 10 (part of the data is also illustrated in FIG. 8).

In the usual authentication mode, the authentication of the user is performed when the authenticated printing process is performed. Because of this, in a stand-by state, the printing apparatus 10 displays an operation screen 121 in the operation panel 150 to accept the operation selected by the user. The user can display the list of hold data items by selecting “Hold” in this screen 121.

When receiving the selection of “Hold”, the printing apparatus 10 displays the list of hold data items which don't require authentication (screen 122). Namely, the data items having the authentication flag of “0” are extracted from among all the data items stored in the hold area 183 and displayed in the screen 122. When one of the hold data items displayed in this screen 122 is selected, the print setting screen 125 for the selected hold data item is displayed, and the print process can be actually performed.

When an “authentication” button displayed in this screen 122 is selected, the printing apparatus 10 displays an authentication screen 123 in the operation panel 150 where a security code can be entered for performing authentication. In this case, it is assumed that “22222” is entered to the authentication ready screen 123 as the security code which is assigned to user “BBBB” corresponding to a user number “2”. By this process, the printing apparatus 10 is notified that the user “BBBB” corresponding to the user number “2” has operated. Incidentally, when a security code which is not registered is entered, the authentication screen 123 is displayed again to prompt the user to enter another security code.

After performing the authentication of the user, the printing apparatus 10 displays the list of hold data items which require authentication of the user (screen 124). In other words, from among the data items stored in the hold area 183, the data items having the authentication flag of “1” and belonging to the user number “2” are extracted and displayed. The authenticated printing option is indicated in the list by a key mark which is displayed in association with each data item if applicable. As has been discussed above, also in the case of the present embodiment, the selection of printing items is made easy by separately displaying the list of the data items which require authentication and the list of the data items which don't require authentication.

When one of the hold data items displayed in this screen 124 and requiring authentication is selected, the print setting screen 125 for the selected hold data item is displayed, and the print process can be actually performed. It is possible to select another hold data item after printing the hold data item. In this case, since the authentication of the user has already been performed, this another hold data item can be printed without repeating authentication. Also, when a “no-authentication” button is selected, the list of the data items which don't require authentication is displayed again (screen 122).

When the “authentication” button displayed in this screen 122 is selected, since the authentication of the user has already been performed, the printing apparatus 10 displays the screen 124 without requiring authentication in the authentication screen 123. However, if a predetermined time elapsed after completing authentication, the printing apparatus 10 exits the authenticated state and requires authentication of the user again. Meanwhile, if the user has been authenticated as an administrator in the authentication screen 123, it is possible to display in the screen 124 the list of the hold data items of all the users which require authentication.

### 2-1) Prior Authentication Mode and Authenticated Printing Process of “Direct Printing”

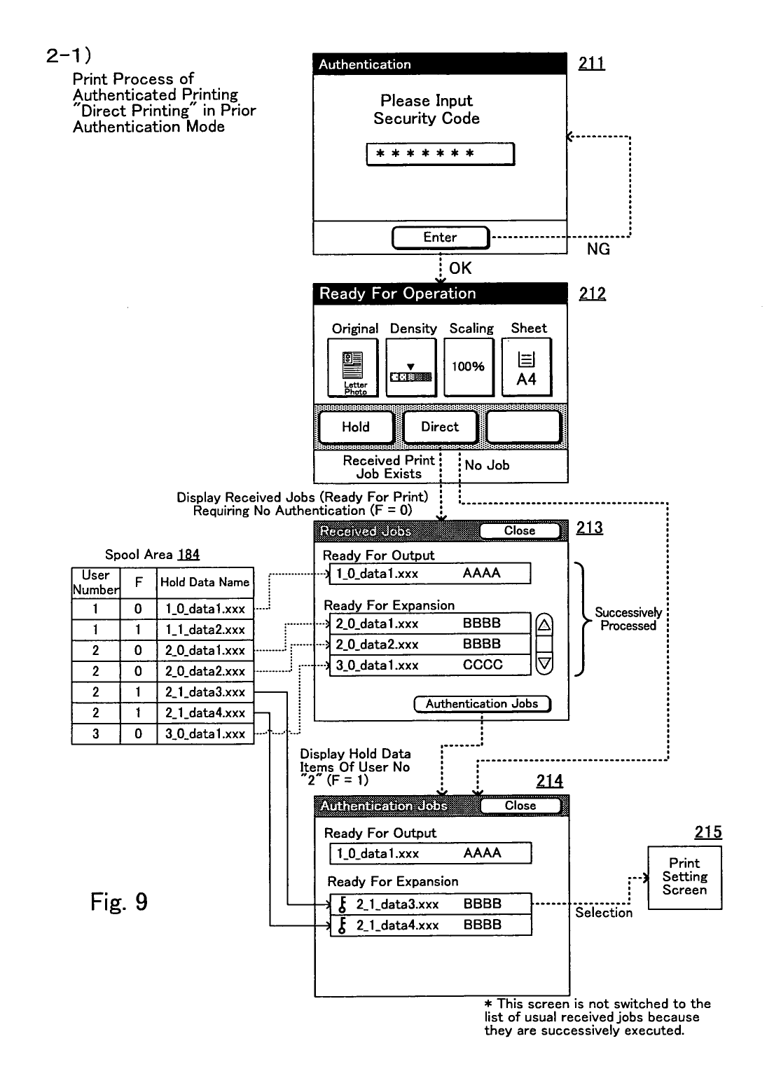

The following is a description of the authenticated printing process of “direct printing” in the prior authentication mode with reference to FIG. 9. A spool area 184 is defined in the storage device 180 of the printing apparatus 10 for temporarily storing print jobs which are transmitted from each PC 20 but have not been done yet. The data of the print job is deleted when this print job is executed. In this example, it is assumed that the data as illustrated in FIG. 9 is stored in the spool area 184.

When the printing apparatus 10 is operated in the prior authentication mode, the authentication of the user is required in advance. Because of this, in the prior authentication mode, an authentication ready screen 211 is displayed in a stand-by state for entering a security code on the operation panel 150 of the printing apparatus 10. In this case, it is assumed that “22222” is entered to the authentication ready screen 111 as the security code which is assigned to user “BBBB” corresponding to a user number “2”. By this process, the printing apparatus 10 is notified that the user “BBBB” corresponding to the user number “2” has operated. Incidentally, when a security code which is not registered is entered, the authentication ready screen 111 is displayed again to prompt the user to enter another security code.

After performing the authentication of the user, the printing apparatus 10 displays the operation screen 212 on the operation panel 150 and accepts the operation selected by the user of the user number “2”. The user of the user number “2” can display a list of accepted print jobs by selecting the “direct print” in this screen.

When receiving the selection of the “direct print”, the printing apparatus 10 displays the list of print jobs which don't require authentication (screen 213). The list includes print jobs whose data has been expanded and which are waiting for output, and print jobs which are waiting for data expansion. These two groups of print jobs are separately displayed. Namely, the data items having the authentication flag of “0” are extracted from among all the data items stored in the spool area 184, and displayed in the screen 213 after confirming the printing states. In this example as illustrated, the hold data relating to all the users are displayed. However, only the hold data relating to the user “BBBB” corresponding to the user number “2 and having the authentication flag of “0” may be displayed. The print jobs displayed in this screen 213 are successively executed. Because of this, the print job state is dynamically changed.

When an “authentication job” button displayed in this screen 213 is selected, the printing apparatus 10 displays the list of the print jobs which require authentication of the user (screen 214). In other words, from among the data items stored in the spool area 184, the data items having the authentication flag of “1” and belonging to the user number “2” are extracted and displayed. The authenticated printing option is indicated in the list by a key mark which is displayed in association with each data item if applicable. In the case of the present embodiment, as described above, the selection of printing items is made easy by separately displaying the list of the print jobs which require authentication and the list of the print jobs which don't require authentication.

When one of the print jobs displayed in this screen 214 and requiring authentication is selected, the print setting screen 215 for the selected print job is displayed, and the authentication print process can be actually performed. In the direct print mode, since the print jobs which don't require authentication are successively executed and the print job states are dynamically changed, there is no button for switching the screen 214 to the screen 213 in this embodiment. However, it is possible to provide a button for switching the screen 214 to the screen 213.

Incidentally, if a predetermined time elapsed after the authentication of the user in the authentication ready screen 211, the printing apparatus 10 exits the authenticated state and displays the authentication ready screen 211 again. Alternatively, it is possible to disable the authenticated state by user's operation or the like. Meanwhile, if the user has been authenticated as an administrator in the authentication ready screen 211, it is possible to display in the screen 214 the list of the print jobs of all the users which require authentication.

### 2-2) Usual Authentication Mode and Authenticated Printing Process of “Direct Printing”

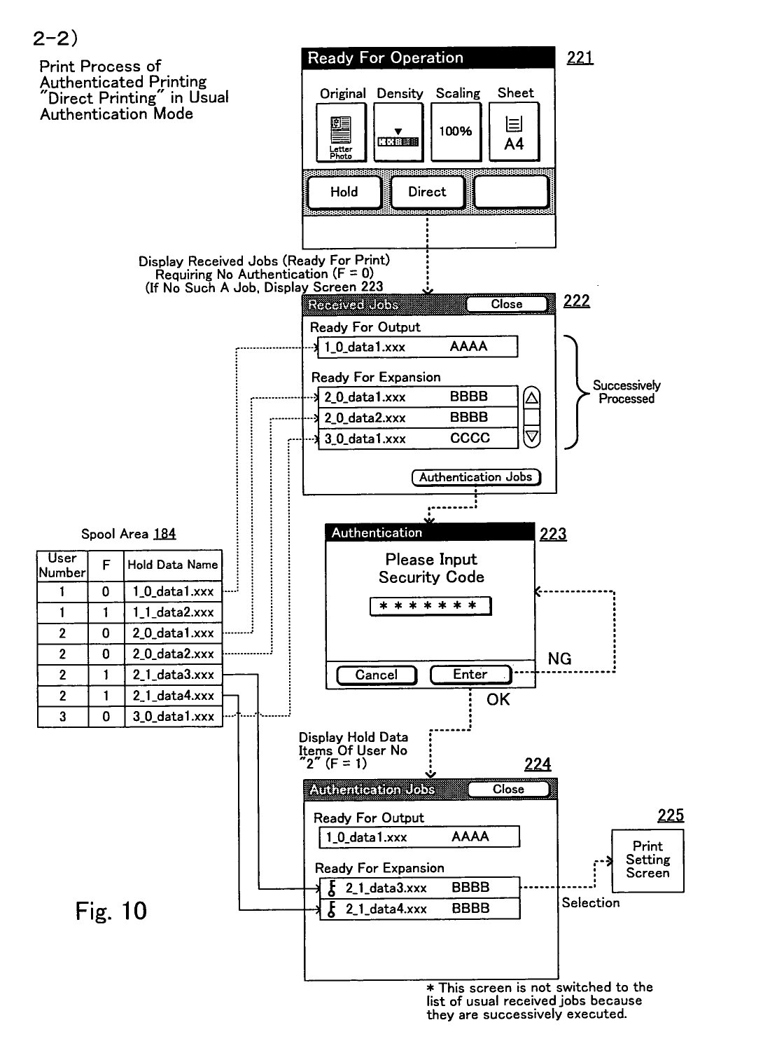

Next is a description of the authenticated printing process of “direct printing” in the usual authentication mode with reference to FIG. 10. It is also assumed that the data as illustrated in FIG. 10 is stored in the spool area 184 of the printing apparatus 10.

In the usual authentication mode, the authentication of the user is performed when the authenticated printing process is performed. Because of this, in a stand-by state, the printing apparatus 10 displays an operation screen 221 in the operation panel 150 to accept the operation performed by the user. The user can display the list of print jobs by selecting the “direct print” in this screen 221.

When receiving the selection of the “direct print”, the printing apparatus 10 displays the list of print jobs which don't require authentication (screen 222). The list includes print jobs whose data has been expanded and which are waiting for output, and print jobs which are waiting for data expansion. These two groups of print jobs are separately displayed. Namely, the data items having the authentication flag of “0” are extracted from among all the data items stored in the spool area 184, and displayed in the screen after confirming the printing states. The print jobs displayed in this screen 222 are successively executed. Because of this, the print job state is dynamically changed.

When an “authentication job” button displayed in this screen 222 is selected, the printing apparatus 10 displays an authentication screen 223 in the operation panel 150 where a security code can be entered for performing authentication. In this case, it is assumed that “22222” is entered to the authentication screen 223 as the security code which is assigned to user “BBBB” corresponding to a user number “2”. By this process, the printing apparatus 10 is notified that the user “BBBB” corresponding to the user number “2” has operated. Incidentally, when a security code which is not registered is entered, the authentication ready screen 223 is displayed again to prompt the user to enter another security code.

After the authentication of the user, the printing apparatus 10 displays the list of print jobs the list of print jobs which require authentication of the user (screen 224). In other words, from among the data items stored in the spool area 184, the data items having the authentication flag of “1” and belonging to the user number “2” are extracted and displayed. The authenticated printing option is indicated in the list by a key mark which is displayed in association with each data item if applicable. As has been discussed above, also in the case of the present embodiment, the selection of printing items is made easy by separately displaying the list of the data items which require authentication and the list of the data items which don't require authentication.

When one of the print jobs displayed in this screen 224 and requiring authentication is selected, the print setting screen 225 for the selected print job is displayed, and the authentication print process can be actually performed. In the direct print mode, since the print jobs which don't require authentication are successively executed and the print job state is dynamically changed, there is no button for switching the screen 224 to the screen 222 in this embodiment. However, it is possible to provide a button for switching the screen 224 to the screen 222 in this embodiment. Meanwhile, if the user has been authenticated as an administrator in the authentication screen 223, it is possible to display in the screen 224 the list of the print jobs of all the users which require authentication.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

What is claimed is:

1. A printing apparatus provided with authenticated printing functionality and performing a print process when a user is successfully authenticated, said printing apparatus comprising:
a print information storage unit operable to store print data and information on whether or not authentication is required when a print data item is printed on a sheet, the print data item and the information being associated with each other; and
a display unit operable to display a list of print data items which are stored in said print information storage unit in order that the user can select a print data item to be printed with reference to this list,
wherein said display unit displays a first list containing the print data items that require authentication in a first screen, and displays a second list containing the print data items that don't require authentication in a second screen different than the first screen.

2. The printing apparatus as claimed in claim 1
wherein said print information storage unit stores each print data item together with a user identifier which is associated with this each print data, wherein
wherein a user information storage unit is further provided for storing the user identifier and authentication information in association with each other,
wherein an authentication unit is further provided for performing authentication of the user on the basis of the authentication information,
wherein said display unit displays an authentication screen in which the user can perform authentication by said authentication unit in advance of displaying the list of the print data items that require authentication, and
wherein, after the user performs authentication, said display unit displays the list of the print data items that require authentication and are associated with the user identifier relating to this authentication.

3. The printing apparatus as claimed in claim 2
wherein said display unit does not display the authentication screen when only the print data items that don't require authentication are displayed.

4. The printing apparatus as claimed in claim 2
wherein said display unit switches between the screen displaying the print data items that don't require authentication and the screen displaying the print data items that require authentication in response to an operation by the user, and
wherein, when said display unit displays the screen displaying the print data items that require authentication, without requiring authentication again, after switching from the screen displaying the print data items that require authentication to the screen displaying the print data items that don't require authentication.

5. The printing apparatus as claimed in claim 1 further comprising a nonvolatile storage device
wherein the print data items are stored in said nonvolatile storage device.
